(19) United States
(12) Patent Application Publication
(10) Pub. No.: US 2010/0096978 A1
(43) Pub. Date: Apr. 22, 2010

(54) Light Emissive Device

(75) Inventor: Richard Wilson, Cambridge (GB)

Correspondence Address: MARSHALL, GERSTEIN & BORUN LLP, 233 SOUTH WACKER DRIVE, 6300 SEARS TOWER, CHICAGO, IL, 60606-6357, US

(73) Assignees: CDT Oxford Limited, Cambridgeshire (GB); Sumation Co. Limited, Tokyo (JP)

(21) Appl. No.: 12/444,170

(22) PCT Filed: Oct. 3, 2007
(86) PCT No.: PCT/GB2007/003746

§ 371 Date: May 21, 2009

(30) Foreign Application Priority Data
Oct. 10, 2006 (GB) 0620046.3

(51) Int. Cl. C09K 11/06; H01J 1/63

(52) U.S. Cl. 313/504; 252/301.16; 252/301.35; 252/301.21

(57) ABSTRACT

A composition for use in an organic light emissive device, the composition comprising a fluorescent organic light emissive material and a phosphorescent organic light emissive material of the same colour.

### FIELD OF INVENTION

The present invention relates to organic light emissive devices and to compositions for use in manufacturing organic light emissive devices.

### BACKGROUND OF THE INVENTION

Organic light emissive devices (OLEDs) generally comprise a cathode, an anode and an organic light emissive region between the cathode and the anode. Light emissive organic materials may comprise small molecular materials such as described in U.S. Pat. No. 4,539,507 or polymeric materials such as those described in PCT/WO90/13148. The cathode injects electrons into the light emissive region and the anode injects holes. The electrons and holes combine to generate photons.

FIG. 1 shows a typical cross-sectional structure of an OLED. The OLED is typically fabricated on a glass or plastic substrate 1 coated with a transparent anode 2 such as an indium-tin-oxide (ITO) layer. The ITO coated substrate is covered with at least a layer of an electroluminescent organic material 3 and cathode material 4 of low work function metal such as barium is applied, optionally with a capping layer of aluminium (not shown). Other layers may be added to the device, for example to improve charge transport between the electrodes and the electroluminescent material.

There has been a growing interest in the use of OLEDs in display applications because of their potential advantages over conventional displays. OLEDs have relatively low operating voltage and power consumption and can be easily processed to produce large area displays. On a practical level, there is a need to produce OLEDs which are bright and operate efficiently but which are also reliable to produce and stable in use.

OLEDs may also be used in lighting applications, such as backlights for flat panel displays. Here, there is particular interest in producing OLEDs which emit white light. However, whilst proposals have been made to fabricate OLEDs capable of producing light with CIE (Commission Internationale d'Eclairage) coordinates approximating to white, the present applicants are not aware of such OLEDs being successfully fabricated for practical use.

U.S. Pat. No. 5,683,823 is concerned with an electroluminescent device having a fluorescent emitting layer including a fluorescent red emitting material dispersed in a fluorescent host material that emits in the blue green regions so that the light produced is said to be substantially white.

U.S. Pat. No. 6,127,693 provides a light-emitting diode (LED) which can emit near white light. The organic light-emitting layer of the device contains a blend of a fluorescent blue light emitting poly(paraphenylene vinylene) and a fluorescent red light emitting alkoxy substituted PPV derivative such that the LED can emit sun light-like yellowish white light.

Chen et al in Polymer Preprints, 41, 835 (2000) describes light emitting diodes which are purported to emit white light. Double-layer devices are described which include a doped blue-green polymer layer adjacent a cross-linked hole transport layer which emits red light by charge trapping. The blue/green layer consists of 9,9-bis(2′-ethyl hexyl)-polyfluorene (DEHF) which is doped with a green fluorescent dye pyrromethene 546 (Py546). The presence of the green dopant dye is required to achieve the white emission reported as a combination of three distinct emissions in blue, green and red.

US 2005/013289 is said to provide a white organic light-emitting device. A host having blue luminescence property and a guest having one of orange and red luminescence properties are doped into the emission layer. A material having green luminescence property is included in the electron transport layer.

EP 1434284 is concerned with white light-emitting organic electroluminescent devices. The devices include at least two organic electroluminescent (EL) materials and at least one photoluminescent (PL) material. The combination of blue and red EL materials and a green PL material is disclosed to produce white light.

Gong et al, in Advanced Materials, 17, 2053-2058 (2005), discloses multilayer white-light-emitting PLEDs fabricated by using a blend of luminescent semiconducting polymers and organometallic complexes as the emission layer. The blend comprises a blue fluorescent polymer, a green fluorescent polymer and a red phosphorescent organometallic complex.

In summary of the above, it is known to try to produce white light by mixing blue and red emitters, and optionally include green emitters.

However, a need exists for an organic light emissive device which is sufficiently stable and operates at a level of efficiency suitable for practical use as a white light source for lighting applications.

### SUMMARY OF THE INVENTION

The present inventors have found that devices containing fluorescent red emitting material and fluorescent blue emitting material colour shift towards the blue region over the lifetime of the device. The present inventors have further found that devices containing phosphorescent red emitting material and fluorescent blue emitting material colour shift towards the red region over the lifetime of the device. While not being bound by theory, it is postulated that the photoluminescent efficiency of the fluorescent red material decreases relative to that of the blue material during the lifetime of these devices whereas the photoluminescent efficiency of the phosphorescent red material increases relative to that of the blue material during the lifetime of these devices. It is also postulated that the change in rate of energy transfer (e.g. by Förster transfer) between the red and blue materials may contribute to these observations. Clearly it is desirable to have a device for which the emission colour does not significantly shift over the lifetime of the device.

The present inventors have solved the aforementioned problem by providing a device in which both fluorescent and phosphorescent red material are provided along with the blue emissive material. Such a device is capable of emitting a stable white light which does not significantly colour shift over the lifetime of the device. During the lifetime of the device the proportion of red light emitted by the fluorescent red material decreases relative to the proportion of red light emitted by the phosphorescent red material. The two components compensate for each other and the overall emission spectrum of the device remains relatively stable with the overall proportion of red and blue light remaining steady.

The present inventors have realized that the principles in the aforementioned white emissive device are applicable more generally to any organic light emissive device in which colour stability is a problem. In particular, the different stability properties of fluorescent and phosphorescent materials can be utilized to offset each other during the lifetime of a device to obtain an overall emission spectrum which is more stable over the lifetime of an organic light emissive device.

In light of the above, in accordance with the present invention there is provided a composition for use in an organic light emissive device, the composition comprising a fluorescent organic light emissive material and a phosphorescent organic light emissive material of the same colour.

While the inventors are aware that compositions are known which comprise a fluorescent organic light emissive material and a phosphorescent organic light emissive material of different colours, the inventors are not aware that anyone has used a fluorescent organic light emissive material and a phosphorescent organic light emissive material of the same colour in an organic light emissive device. Indeed, the provision of two different materials having the same colour would hitherto have been thought unnecessary. However, the present inventors' study of the emission characteristics of fluorescent and phosphorescent materials over the lifetime of an organic light emissive device has shown that the provision of a fluorescent organic light emissive material and a phosphorescent organic light emissive material of the same colour is advantageous for enhancing the colour stability of these devices.

By “the same colour” we mean that, for example, the materials are either both red electroluminescent materials, both yellow electroluminescent materials, both green electroluminescent materials, or both blue electroluminescent materials. Preferably, the materials are either both red electroluminescent materials, both yellow electroluminescent materials or both green electroluminescent materials given that blue electroluminescent materials are generally fluorescent. Most preferably, the materials are both red electroluminescent materials. It has been found that fluorescent and phosphorescent red emissive materials are particularly useful in a white emissive device which is more colour stable over the lifetime of the device. Alternatively, the materials may be both yellow electroluminescent materials in, for example, a white emissive composition comprising a blue electroluminescent materials.

By “red electroluminescent material” is meant an organic material that by electroluminescence emits radiation having a wavelength in the range of 600-750 nm, preferably 600-700 nm, more preferably 610-650 nm and most preferably having an emission peak around 650-660 nm. For the purposes of the present invention, red emission may be defined as light having a CIE x co-ordinate greater than or equal to 0.4, preferably 0.64, and a CIE y co-ordinate less than or equal to 0.4, preferably 0.33.

By “green electroluminescent material” is meant an organic material that by electroluminescence emits radiation having a wavelength in the range of 510-580 nm, preferably 510-570 nm.

By “blue electroluminescent material” is meant an organic material that by electroluminescence emits radiation having a wavelength in the range of 400-500 nm, more preferably 430-500 nm. For the purposes of the present invention, blue emission may be defined as light having a CIE x co-ordinate less than or equal to 0.25, more preferably less than or equal to 0.2, and a CIE y co-ordinate less than or equal to 0.25, more preferably less than or equal to 0.2.

White light is preferably light having a CIE x coordinate equivalent to that emitted by a black body at 3000-9000K and CIE y coordinate within 0.05 of the CIE y co-ordinate of said light emitted by a black body. “Pure” white light has CIE coordinates 0.33, 0.33.

Preferably, the main peak in the emission spectra of the fluorescent and phosphorescent materials overlaps. More preferably, the full width at half maximum (FWHM) of the main peak in the emission spectra of these two materials overlaps. More preferably still, the peak wavelength of the main peak in the emission spectra of the two materials are within 40 nm of each other, 20 nm of each other, or most preferably within 10 nm of each other.

According to an embodiment of the present invention, the composition comprises a further organic light emissive material which has a different colour emission. The further organic light emissive material may be a fluorescent material such as, for example, a blue fluorescent material. It has been found that the combination of a blue fluorescent material with fluorescent and phosphorescent red materials is useful in forming a white emissive device having good colour stability. However, it is envisaged that other combinations of materials utilizing the present inventive concept may be provided. For example, it is possible to produce a colour stable device comprising fluorescent and phosphorescent materials having a first colour, fluorescent and phosphorescent materials having a second colour different to the first colour, and a further light emissive material. Such a device may be a white emissive device comprising fluorescent and phosphorescent red materials, fluorescent and phosphorescent green materials, and a fluorescent blue material. Here, the colour stability of both the red and green materials is accounted for.

One might expect that the emission from the phosphorescent material would be quenched by the fluorescent material of the same colour. However, it has surprisingly been found that this is not the case. Preferably, the phosphorescent and fluorescent material of the same colour are provided in low concentrations in the composition, for example, less than 5 mol % relative to the further light emissive material, more preferably less than 1 mol %. It has been postulated that by providing a red or yellow phosphorescent and red or yellow fluorescent material colour at low concentration relative to a blue light emissive material, problems with quenching are reduced or eliminated because the predominant component of the composition is the blue light emissive material which has a higher triplet energy than the red phosphorescent material.

In the case where the fluorescent or phosphorescent material is provided as a repeat unit in a polymer, the molar percentage of that material is the number of moles of that repeat unit relative to all other units (polymeric or non-polymeric) within the composition.

The materials in the composition may be provided as separate materials blended together in a mixture. Alternatively, the materials in the composition may be chemically bound to each other. In one particular preferred arrangement, the materials are chemically bound together in a co-polymer. For example, a white emissive co-polymer may be provided which comprises fluorescent red emissive units, phosphorescent red emissive units and fluorescent blue emissive units. Combinations of blending and chemically binding the materials in the composition are also possible. For example, the composition may comprise a co-polymer including fluorescent red emissive units and fluorescent blue emissive units, the co-polymer being blended with a phosphorescent red emissive material to provide a white emissive mixture.

Other non-emissive materials may be provided in the composition such as organic hole transporting materials and/or organic electron transporting materials. Alternatively, or additionally, one or more of the emissive materials may be a hole transporting and/or electron transporting material. It is preferred that the composition comprises emissive copolymers comprising hole transporting and/or electron transporting repeat units in addition to the emissive repeat units.

Preferably, the materials in the composition are solution processable and the composition comprises a solvent in which the materials are dissolved or disposed therein as a dispersion. Thus, the composition can be deposited utilizing solution processing methods. The compositions of the present invention may be deposited by any solution processing method, for example ink-jet printing, spin-coating, dip-coating, roll-printing or screen printing.

One or more of the materials in the composition may be cross-linkable. In such an arrangement, an organic light-emissive device can be manufactured by depositing the composition and then cross-linking one or more of the materials to form a cross-linked layer which is more robust and stable.

In one arrangement, one or more of the materials in the composition are selectively cross-linkable such that an interpenetrating or semi-interpenetrating network can be formed by selective crosslinking after deposition of the composition. According to one embodiment, the composition comprises two polymers. If only one of the polymers is cross-linked, the other being, for example, a simple linear non-functionalised polymer, which is disposed through the cross-linked matrix as a continuous phase as opposed to a phase separated aggregate, a semi-interpenetrating network is formed. Alternatively, both polymers may be selectively cross-linked providing a first cross-linked matrix which is disposed through a second cross-linked matrix as a continuous phase, whereby the first cross-linked matrix and the second cross-linked matrix provide an interpenetrating network. There is little or no cross-linking between the two polymers in such arrangements.

According to another aspect of the present invention there is provided an organic light emissive device comprising: an anode; a cathode; and an organic light emissive region between the anode and the cathode, which region comprises a fluorescent organic light emissive material and a phosphorescent organic light emissive material of the same colour.

The fluorescent organic light emissive material and phosphorescent organic light emissive material of the same colour may be provided in separate layers or in the same layer, preferably in the same layer.

The organic light emissive device may be used in a backlight for a flat panel display as well as for other lighting applications, in particular as a source of ambient lighting.

According to another aspect of the present invention there is provided an organic light emissive device which emits white light that colour shifts less than 0.02 CIE co-ordinates over a time period in which emission from the organic light emissive device drops to half its original luminance during driving. That is, emission from the organic light emissive device remains within a circle on the CIE chart having a radius of 0.02 CIE co-ordinates and centred in the white region of the CIE chart. More preferably, the radius of the circle is less than 0.015 CIE coordinates, most preferably less than 0.013 CIE coordinates.

Typically, the device comprises a three emissive component system such that no other emissive materials are present. For example, the device may comprise a red fluorescent material, a red phosphorescent material and a blue electroluminescent material.

Preferably, the blue electroluminescent material comprises a blue electroluminescent polymer, more preferably a conjugated polymer, typically a copolymer. Preferably, the polymer is solution processable. Preferably, the blue electroluminescent material is fluorescent.

The blue electroluminescent material is preferably a semiconductive polymer and may comprise a triarylamine repeat unit. Particularly preferred triarylamine repeat units are shown in formulae 1-6:

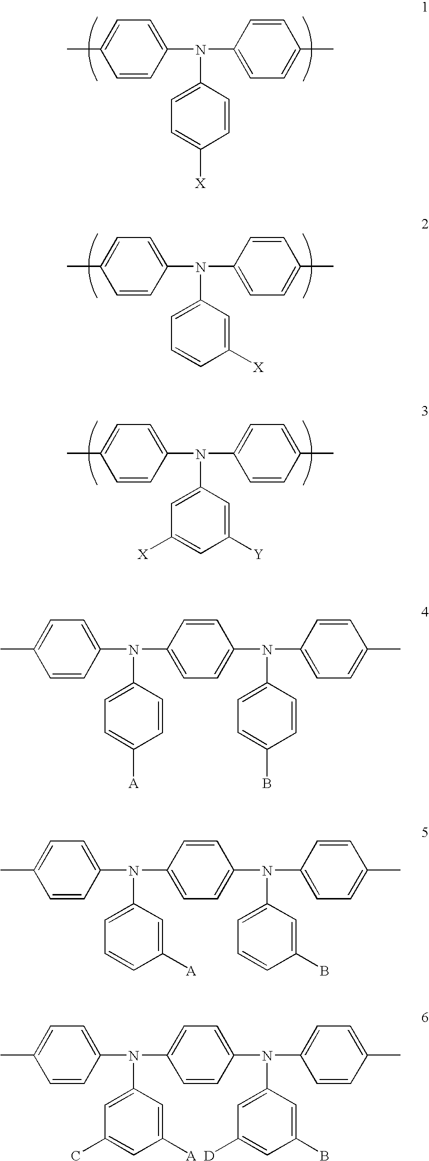

wherein X, Y, A, B, C and D are independently selected from H or a substituent group. More preferably, one or more of X, Y, A, B, C and D is independently selected from the group consisting of optionally substituted, branched or linear alkyl, aryl, perfluoroalkyl, thioalkyl, cyano, alkoxy, heteroaryl, alkylaryl and arylalkyl groups. Most preferably, X, Y, A and B are C₁₋₁₀ alkyl. Any two phenyl groups of repeat units 1-6 may be linked by a direct bond or by a divalent moiety, preferably a heteratom, more preferably O or S.

Preferably, the red fluorescent material comprises a red electroluminescent polymer, more preferably a conjugated polymer, typically a copolymer. Preferably, the polymer is solution processable.

Preferred red fluorescent materials include polymers comprising an optionally substituted repeat unit of formula (8):

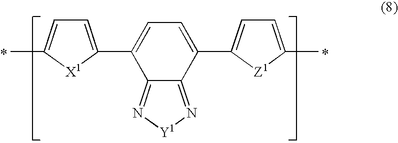

wherein X¹, Y¹ and Z¹ are each independently O, S, CR₂, SiR₂ or NR, more preferably O or S, most preferably S; and each R is independently alkyl, aryl or H. A preferred substitutent for the repeat unit of formula (8) is C₁₋₂₀ alkyl which may be present on one or more of the rings of the repeat unit of formula (8).

In the case where the repeat unit of formula (8) is substituted the substitution preferably comprises one or more substituents selected from the group consisting of alkyl, alkoxy and optionally substituted aryl or heteroaryl.

More preferably, the red fluorescent material is a copolymer comprising an optionally substituted repeat unit of formula (8) and electron transporting and/or hole transporting repeat units. Particularly preferred electron transporting repeat units comprise optionally substituted, 2,7-linked fluorenes, most preferably repeat units of formula (7):

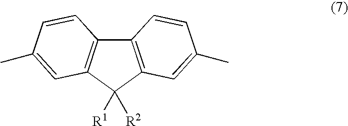

wherein R¹ and R² are independently selected from hydrogen or optionally substituted alkyl, alkoxy, aryl, arylalkyl, heteroaryl and heteroarylalkyl. More preferably, at least one of R¹ and R² comprises an optionally substituted C₄-C₂₀ alkyl or aryl group.

Particularly preferred hole transporting repeat units in a red fluorescent copolymer comprise the triarylamine repeat units of formulae 1-6.

An exemplary red phosphorescent material may be a metal complex comprising a metal (M) surrounded by three optionally substituted bidentate ligands. An example of such a red phosphorescent material is tris(phenylisoquinoline)iridium (III). The metal complex may be substituted with solubilising substituents such as alkyl or alkoxy groups. The red phosphorescent material may form the core of a dendrimer, surrounded by one or more dendrons. Preferably, the dendrons are conjugated. Preferably, the dendrons comprise surface groups for solubilisation of the dendrimer. Particularly preferred dendrons are disclosed in WO 02/066552. The red phosphorescent material may also be provided as a repeat unit and/or an end-capping group in a polymer. In the case where it is provided as a repeat unit, the red phosphorescent material may be provided as a repeat unit in the polymer main chain or as a substituent pendant from the main chain.

A hole transporting layer comprising hole transporting material may be present between the anode and the organic light emissive region. Suitable materials for the hole transporting material include hole transporting polymers, particularly polymers comprising a triarylamine repeat unit. Preferred triarylamine repeat units include those having general formulae 1 to 6.

Particularly preferred hole transporting polymers of this type are AB copolymers of a fluorene repeat unit and a triarylamine repeat unit.

### BRIEF DESCRIPTION OF THE DRAWINGS

The present invention now will be described in more detail with reference to the accompanying drawings, in which:

FIG. 1 shows a typical cross section of an OLED;

FIG. 2 shows how the emission spectrum changes during driving for a device comprising a red fluorescent material and a blue fluorescent material; and

FIG. 3 shows how the emission spectrum changes during driving for a device comprising a red fluorescent material, a red phosphorescent material and a blue fluorescent material.

### DETAILED DESCRIPTION

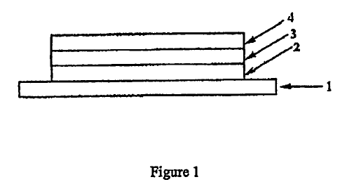

With reference to FIG. 1, the architecture of an electroluminescent device according to the invention comprises a transparent glass or plastic substrate 1, an anode 2 of indium tin oxide and a cathode 4. An organic light emissive region 3 is provided between anode 2 and cathode 4.

Further layers may be located between anode 2 and cathode 3, such as charge transporting, charge injecting and/or charge blocking layers.

In particular, it is desirable to provide a conductive hole injection layer formed of a doped organic material located between the anode 2 and the electroluminescent layer 3 to assist hole injection from the anode into the layer or layers of semiconducting polymer. Examples of doped organic hole injection materials include poly(ethylene dioxythiophene) (PEDT), in particular PEDT doped with polystyrene sulfonate (PSS) as disclosed in EP 0901176 and EP 0947123, or polyaniline as disclosed in U.S. Pat. No. 5,723,873 and U.S. Pat. No. 5,798,170.

If present, a hole transporting layer located between anode 2 and electroluminescent layer 3 preferably has a HOMO level of less than or equal to 5.5 eV, more preferably around 4.8-5.5 eV.

If present, an electron transporting layer located between electroluminescent layer 3 and cathode 4 preferably has a LUMO level of around 3-3.5 eV.

The organic light emissive region 3 comprises the fluorescent organic light emissive material and phosphorescent organic light emissive material of the same colour.

Cathode 4 is selected from materials that have a workfunction allowing injection of electrons into the organic light emissive region. Other factors influence the selection of the cathode such as the possibility of adverse interactions between the cathode and the organic light emissive region. The cathode may consist of a single material such as a layer of aluminium. Alternatively, it may comprise a plurality of metals, for example a bilayer of calcium and aluminium as disclosed in WO 98/10621, elemental barium disclosed in WO 98/57381, Appl. Phys. Lett. 2002, 81(4), 634 and WO 02/84759 or a thin layer of a metal compound to assist electron injection, for example lithium fluoride disclosed in WO 00/48258 or barium fluoride, disclosed in Appl. Phys. Lett. 2001, 79(5), 2001 or barium oxide. In order to provide efficient injection of electrons into the device, the cathode preferably has a workfunction of less than 3.5 eV, more preferably less than 3.2 eV, most preferably less than 3 eV.

Optical devices tend to be sensitive to moisture and oxygen. Accordingly, the substrate preferably has good barrier properties for prevention of ingress of moisture and oxygen into the device. The substrate is commonly glass, however alternative substrates may be used, in particular where flexibility of the device is desirable. For example, the substrate may comprise a plastic as in U.S. Pat. No. 6,268,695 which discloses a substrate of alternating plastic and barrier layers or a laminate of thin glass and plastic as disclosed in EP 0949850.

The device is preferably encapsulated with an encapsulant (not shown) to prevent ingress of moisture and oxygen. Suitable encapsulants include a sheet of glass, films having suitable barrier properties such as alternating stacks of polymer and dielectric as disclosed in, for example, WO 01/81649 or an airtight container as disclosed in, for example, WO 01/19142. A getter material for absorption of any atmospheric moisture and/or oxygen that may permeate through the substrate or encapsulant may be disposed between the substrate and the encapsulant.

In a practical device, at least one of the electrodes is semi-transparent in order that light may be absorbed (in the case of a photoresponsive device) or emitted (in the case of an OLED). Where the anode is transparent, it typically comprises indium tin oxide. Examples of transparent cathodes are disclosed in, for example, GB 2348316.

The embodiment of FIG. 1 illustrates a device wherein the device is formed by firstly forming an anode on a substrate followed by deposition of an electroluminescent layer and a cathode, however it will be appreciated that the device of the invention could also be formed by firstly forming a cathode on a substrate followed by deposition of an electroluminescent layer and an anode.

Preferred methods for preparation of polymers according to embodiments of the present invention are Suzuki polymerisation as described in, for example, WO 00/53656 and Yamamoto polymerisation as described in, for example, T. Yamamoto, “Electrically Conducting And Thermally Stable π—Conjugated Poly(arylene)s Prepared by Organometallic Processes”, Progress in Polymer Science 1993, 17, 1153-1205. These polymerisation techniques both operate via a “metal insertion” wherein the metal atom of a metal complex catalyst is inserted between an aryl group and a leaving group of a monomer. In the case of Yamamoto polymerisation, a nickel complex catalyst is used; in the case of Suzuki polymerisation, a palladium complex catalyst is used.

For example, in the synthesis of a linear polymer by Yamamoto polymerisation, a monomer having two reactive halogen groups is used. Similarly, according to the method of Suzuki polymerisation, at least one reactive group is a boron derivative group such as a boronic acid or boronic ester and the other reactive group is a halogen. Preferred halogens are chlorine, bromine and iodine, most preferably bromine.

It will therefore be appreciated that repeat units and end groups comprising aryl groups as illustrated throughout this application may be derived from a monomer carrying a suitable leaving group.

Suzuki polymerisation may be used to prepare regioregular, block and random copolymers. In particular, homopolymers or random copolymers may be prepared when one reactive group is a halogen and the other reactive group is a boron derivative group. Alternatively, block or regioregular, in particular AB, copolymers may be prepared when both reactive groups of a first monomer are boron and both reactive groups of a second monomer are halogen.

As alternatives to halides, other leaving groups capable of participating in metal insertion include groups include tosylate, mesylate and triflate.

A single polymer or a plurality of polymers may be deposited from solution to form a layer. Suitable solvents for polyarylenes, in particular polyfluorenes, include mono- or poly-alkylbenzenes such as toluene and xylene. Particularly preferred solution deposition techniques are spin-coating and inkjet printing.

Spin-coating is particularly suitable for devices wherein patterning of the electroluminescent material is unnecessary—for example for lighting applications or simple monochrome segmented displays.

Inkjet printing is particularly suitable for high information content displays, in particular full colour displays. Inkjet printing of OLEDs is described in, for example, EP 0880303.

If multiple layers of the device are formed by solution processing then the skilled person will be aware of techniques to prevent intermixing of adjacent layers, for example by crosslinking of one layer before deposition of a subsequent layer or selection of materials for adjacent layers such that the material from which the first of these layers is formed is not soluble in the solvent used to deposit the second layer.

### EXAMPLES

A white emitting polymer comprising fluorescent blue emitting triarylamine repeat units of formula 4 and fluorescent red emitting repeat units of formula 8 was prepared by Suzuki polymerisation as described in WO 00/53656.

A red phosphorescent dendrimer material comprising tris-(phenylisoquinoline)iridium (III) was prepared as described in WO 02/066552.

Poly(ethylene dioxythiophene)/poly(styrene sulfonate) (PEDT/PSS), available from H C Starck of Leverkusen, Germany as Baytron P® was deposited over an indium tin oxide anode supported on a glass substrate (available from Applied Films, Colo., USA) by spin coating. A hole transporting layer was deposited over the PEDT/PSS layer by spin coating from xylene solution to a thickness of about 10 nm and heated at 180° C. for 1 hour. A blend of the aforementioned fluorescent polymer and phosphorescent dendrimer was deposited over the layer of F8-TFB by spin-coating from xylene solution to a thickness of around 65 nm. A Ba/Al cathode was formed over the polymer by evaporating a first layer of barium to a thickness of up to about 10 nm and a second layer of aluminium to a thickness of about 100 nm over the semiconducting polymer. Finally, the device was sealed using a metal enclosure containing a getter that was placed over the device and glued onto the substrate in order to form an airtight seal.

The devices were pulse driven and the luminance measured until the value dropped to half its initial intensity. Emission spectra were measured initially and after driving when the luminance had dropped to half its initial value.

Results are given in Table 1 below. The first entry “Fluorescent Red” is for a comparative example comprising the white-emitting polymer, i.e. wherein all red emission is fluorescent emission. The second entry “Fluorescent+Phos. Red” is for the example comprising a blend of fluorescent white-emitting polymer and, phosphorescent red material.

| | | | | | Pulsed Lifetime |
|---|---|---|---|---|---|
| | Undriven CIE | Driven CIE | Δ CIE − x | Δ CIE − y | (hrs) |
| Fluorescent Red | (0.295, 0.267) | (0.268, 0.256) | −0.027 | −0.011 | 440 |
| Fluorescent + Phos. Red | (0.308, 0.261) | (0.296, 0.255) | −0.011 | −0.006 | 440 |

It can be seen that there is no significant change in the lifetime of the device when phosphorescent material is included. However, there is a significant difference in the emission spectra in that the colour of the device which only includes the white-emitting material changes significantly when driven whereas the colour of the device which additionally includes the phosphorescent red material does not change very much when driven.

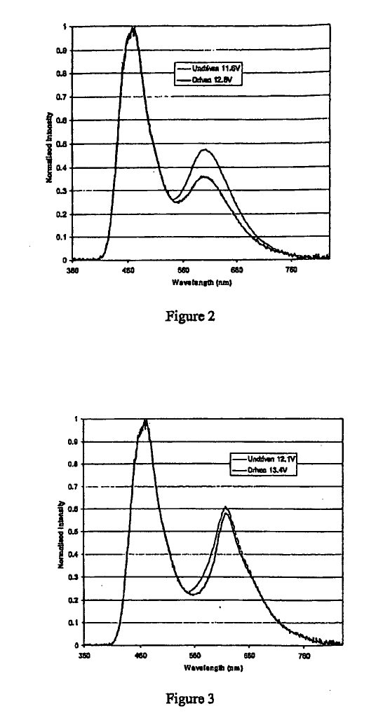

FIG. 2 shows how the emission spectrum changes during driving for the device comprising a fluorescent white-emitting material. FIG. 3 shows how the emission spectrum changes during driving for the device comprising a red phosphorescent material. The top line in each spectrum is the emission spectrum from the undriven device whereas the bottom line in each spectrum is the emission spectrum from the device after driving when the luminance was half its initial value.

It can be seen that the emission intensity in the red region for the device comprising only the fluorescent white-emitting material significantly decreases relative to the emission intensity in the blue region resulting in a blue shift in the colour of the device. However, the emission intensity in the red region for the device which additionally comprises a phosphorescent red emitter remains approximately the same relatively to that of the blue region and thus the colour of the device does not significantly alter.

Results thus indicate that the provision of organic fluorescent and phosphorescent materials of the same colour is advantageous in producing an organic light emissive device with good colour stability over the lifetime of the device.

While this invention has been particularly shown and described with reference to preferred embodiments thereof, it will be understood by those skilled in the art that various changes in form and details may be made therein without departing from the scope of the invention as defined by the appended claims.

1. A composition for use in an organic light emissive device, the composition comprising a fluorescent organic light emissive material and a phosphorescent organic light emissive material of the same color.

2. A composition according to claim 1, wherein the fluorescent organic light emissive material is a polymer.

3. A composition according to claim 1, wherein the fluorescent organic light emissive material is a fluorescent red emissive material.

4. A composition according to claim 3, wherein the fluorescent red emissive material comprises a polymer comprising an optionally substituted repeat unit of formula (8): 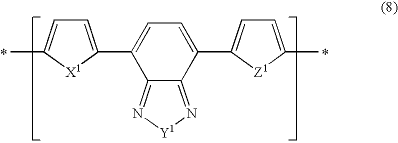
wherein X¹, Y¹ and Z¹ are each independently O, S, CR₂, SiR₂ or NR; and each R is independently alkyl, aryl or H.

5. A composition according to claim 1, wherein the phosphorescent organic light emissive material is an organometallic complex.

6. A composition according to claim 1, wherein the phosphorescent organic light emissive material is a phosphorescent red emissive material.

7. A composition according to claim 6, wherein the phosphorescent red emissive material is tris(phenylisoquinoline)iridium (III) substituted by one or more solubilizing groups.

8. A composition according to claim 1, wherein the fluorescent organic light emissive material and the phosphorescent organic light emissive material are provided as separate materials blended together in a mixture or are chemically bound to each other.

9. A composition according to claim 1, wherein the composition further comprises a further organic light emissive material which has a different color than the fluorescent organic and phosphorescent organic light emissive materials.

10. A composition according to claim 9, wherein the further organic light emissive material is provided as a separate material blended together in a mixture with the fluorescent organic light emissive material and the phosphorescent organic light emissive material or is chemically bound to one or both of the fluorescent organic light emissive material and the phosphorescent organic light emissive material.

11. A composition according to claim 9, wherein the further organic light emissive material is a blue fluorescent material.

12. A composition according to claim 11, wherein the blue fluorescent material comprises a polymer comprising optionally substituted repeat units of any one or more of formulae 1-6: 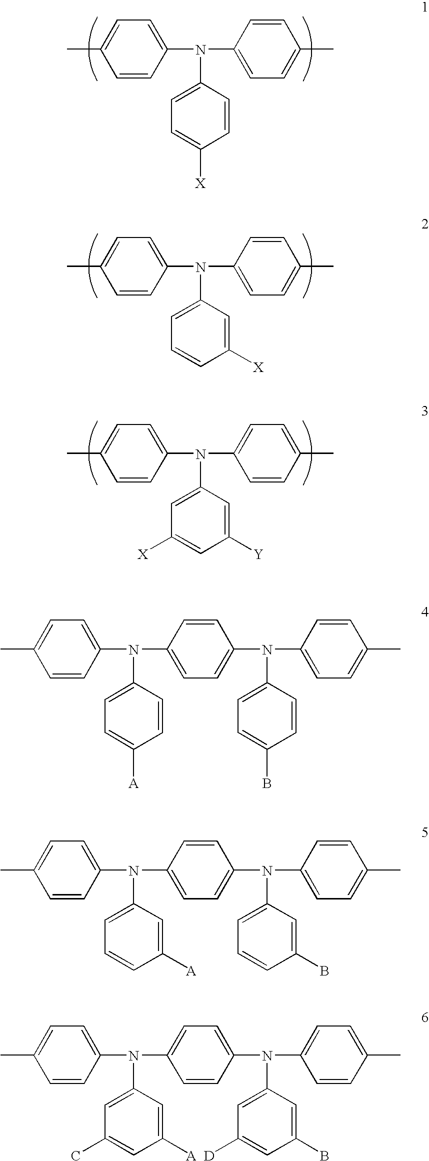
wherein X, Y, A, B, C and D are independently selected from H or a substituent group and any two phenyl groups of repeat units 1-6 may be linked by a direct bond or by a divalent moiety.

13. A composition according to claim 9, wherein the fluorescent organic light emissive material and the phosphorescent organic light emissive material are provided in the composition at a concentration of less than 5% by weight relative to the further light emissive material.

14. A composition according to claim 1, wherein the composition is a white emissive composition.

15. A composition according to claim 14, wherein the white emissive composition has a CIE x coordinate equivalent to that emitted by a black body at 3000-9000K and CIE y coordinate within 0.05 of the CIE y co-ordinate of said light emitted by a black body.

16. A composition according to claim 1, further comprising an organic hole transporting material and/or an organic electron transporting material.

17. An organic light emissive device comprising: an anode; a cathode; and an organic light emissive region between the anode and the cathode, which region comprises a fluorescent organic light emissive material and a phosphorescent organic light emissive material of the same color.

18. An organic light emissive device according to claim 17, wherein the fluorescent organic light emissive material and phosphorescent organic light emissive material are provided in the same layer.

19. An organic light emissive device according to claim 17, wherein the organic light emissive region comprises a composition comprising a fluorescent organic light emissive material and a phosphorescent organic light emissive material of the same color.

20. An organic light emissive device capable of emitting white light that color shifts less than 0.02 CIE co-ordinates over a time period in which emission from the organic light emissive device drops to half its original luminance during driving.

21. An organic light emissive device according to claim 20, that color shifts less than 0.015 CIE coordinates over a time period in which emission from the organic light emissive device drops to half its original luminance during driving.

22. A composition according to claim 4, wherein X1, Y1 and Z1 are each independently O or S.

23. A composition according to claim 4, wherein X1, Y1 and Z1 are each S.

24. A composition according to claim 10, wherein the further organic light emissive material is a blue fluorescent material.

25. A composition according to claim 9, wherein the fluorescent organic light emissive material and the phosphorescent organic light emissive material are provided in the composition at a concentration of less than 1% by weight relative to the further light emissive material.

26. An organic light emissive device according to claim 18, wherein the organic light emissive region comprises a composition comprising a fluorescent organic light emissive material and a phosphorescent organic light emissive material of the same color.

27. An organic light emissive device according to claim 20, that color shifts less than 0.013 CIE coordinates over a time period in which emission from the organic light emissive device drops to half its original luminance during driving.
